(19) United States
(12) Patent Application Publication
(10) Pub. No.: US 2026/0151291 A1
(43) Pub. Date: Jun. 4, 2026

(54) COMBINED MASSAGE DEVICE AND VEHICLE SEAT MOUNTED WITH SAME

(71) Applicant: Adient (Chongqing) Automotive Components Co., Ltd., Chongqing (CN)

(72) Inventors: Jun XU, Chongqing (CN); Yi XIN, Chongqing (CN); Shaobin XU, Chongqing (CN); Wei JIA, Chongqing (CN); Muxing TAN, Chongqing (CN)

(21) Appl. No.: 19/400,560

(22) Filed: Nov. 25, 2025

(30) Foreign Application Priority Data
Nov. 29, 2024 (CN) 202411736917.8

(51) Int. Cl. A61H 15/00

(52) U.S. Cl. CPC A61H 15/0078; A61H 2015/0042; A61H 2201/0149; A61H 2201/1215

(57) ABSTRACT

A combined massage device and a vehicle seat on which the massage device may be mounted. The combined massage device may be fixedly mounted at a shoulder position of the backrest of the vehicle seat. The combined massage device may have a housing assembly, configured to be fixedly mounted inside a seat back. Two rotary massage mechanisms may be disposed at left and right ends of the housing assembly. The rotary massage mechanisms may apply a massage force to a user's back in a continuous rotation manner. Two shiatsu massage mechanisms may be disposed at the left and right ends of the housing assembly, The shiatsu massage mechanisms may be able to intermittently apply a pushing pressure to the user's back in a continuous manner to simulate shiatsu massage. A driving mechanism that may be configured to drive the rotary massage mechanisms and the shiatsu massage mechanisms to operate.

### TECHNICAL FIELD

The device relates to the technical field of massage equipment, and specifically to a combined massage device.

### BACKGROUND ART

With the rapid development of the vehicle industry, vehicles are widely used in work and life. As people's living standards improve, in addition to the basic functions of vehicles meeting people's daily needs, people have higher and higher requirements for the comfort of vehicle seats. The massage function is an indispensable part of comfort, especially during long-distance travel. Maintaining the same posture for a long time can easily lead to physical fatigue and discomfort, which can be effectively relieved with massage seats.

Currently, some vehicle seats with massage functions have been launched on the market. Most massage seats only provide massage for the lower back, neglecting other easily fatigued areas such as the shoulders. The massage methods mainly fall into two categories: airbag massage and mechanical massage. Among them, airbag massage uses the inflation and deflation of airbags to achieve a pushing and retracting massage, but its massage effect is relatively weak and the intensity is too soft, making it difficult to appeal to all consumers. Although mechanical massage can provide sufficient massage intensity, the complex mechanical structure within the extremely limited design space of the backrest frame makes it difficult to maintain a high degree of integration, often resulting in a bulky overall seat structure. Furthermore, a simple mechanical massage structure offers only a single massage mode, and its effect on relieving fatigue is limited.

### SUMMARY

In view of this, the present device provides a combined massage device that has the technical advantages of simple structure and good comfort.

To achieve the above objective, the technical solution of the device is as follows:

A combined massage device, comprising:
a housing assembly, configured to be fixedly mounted inside a seat back;
two rotary massage mechanisms disposed at left and right ends of the housing assembly, wherein the rotary massage mechanisms are able to apply a massage force to a user's back in a continuous rotation manner;
two shiatsu massage mechanisms disposed at the left and right ends of the housing assembly, wherein the shiatsu massage mechanisms are able to intermittently apply a pushing pressure to the user's back in a continuous manner to simulate shiatsu massage;
and a driving mechanism, wherein the driving mechanism is configured to drive the rotary massage mechanisms and the shiatsu massage mechanisms to operate.

With the above structure, the structure is simple, the mechanical massage method provides sufficient massage force, and the combination of the rotary massage mechanism and the shiatsu massage mechanism results in a good massage effect.

Preferably, the left and right ends of the housing assembly are each provided with a first mounting inner hole, the rotary massage mechanism comprises a rotary massage head rotatably disposed in the first mounting inner hole, an outer end portion of the rotary massage head has a first massage portion, and the driving mechanism is able to drive the rotary massage head to rotate in the first mounting inner hole. With the above structure, rotary massage is provided.

Preferably, an outer wall of the rotary massage head is provided with a spiral groove and an annular groove, the annular groove is located at one end away from the first massage portion, one end of the spiral groove is in communication with the annular groove, an inner wall of the first mounting inner hole is provided with a first guide portion protruding inward, the spiral groove and the annular groove are in sliding cooperation with the first guide portion; when the driving assembly drives the rotary massage head to rotate in a forward direction, the rotary massage head ascends and then rotates continuously, and the rotary massage head retracts downward when rotating in a reverse direction. With the above structure, the rotary massage mechanism is pushed out when operating and retracted into the first mounting inner hole when not operating. In cooperation with foaming, this can make the shoulder support surface smooth, thereby preventing it from causing an unpleasant bulging sensation.

Preferably, the left and right ends of the housing assembly are each provided with a second mounting inner hole, the shiatsu massage mechanism comprises a shiatsu massage head rotatably disposed in the second mounting inner hole, a sinusoidal groove is provided on an outer wall of the shiatsu massage head, a second guide portion protruding inward is provided on an inner wall of the second mounting inner hole, the sinusoidal groove is in sliding cooperation with the second guide portion, and the driving mechanism is configured to drive the shiatsu massage head to rotate. With the above structure, shiatsu massage is provided.

Preferably, two second guide portions protruding inward are symmetrically provided on the inner wall of the second mounting inner hole. With the above structure, the shiatsu massage head is subjected to balanced force and moves smoothly.

Preferably, a bottom portion of the rotary massage head is connected to a first gear configured to drive the rotary massage head to rotate, a bottom portion of the shiatsu massage head is connected to a second gear configured to drive the shiatsu massage head to rotate, the first gear and the second gear located at a same end of the housing assembly are engaged in transmission, the driving mechanism comprises an electric motor arranged in a middle portion of the housing assembly, and an output shaft of the electric motor is engaged in power with the two second gears at the two ends of the housing assembly. With the above structure, both the rotary massage mechanism and the shiatsu massage mechanism are driven simultaneously, resulting in a simple and compact structure.

Preferably, the first gears and the second gears at the two ends of the housing assembly are integrally arranged in a planar layout with the electric motor in the middle portion of the housing assembly, and the first gear is located on the outside of the second gear. With the above structure, the structure is compact, thereby avoiding the bulky overall structure caused by integrating the massage mechanism into the seat.

Preferably, the first guide portion is mounted on the inner wall of the first mounting inner hole by means of an elastic element in such a manner that the first guide portion is able to float vertically. With the above structure, it allows the first guide portion to slide more smoothly within the spiral groove and the annular groove, ensuring that the first guide portion smoothly enters the spiral groove when the rotary massage head retracts.

Preferably, a buffer groove is widened at the connection between the spiral groove and the annular groove. With the above structure, the first guide portion can smoothly transition between the spiral groove and the annular groove under the guidance of the buffer groove.

The present device further provides a vehicle seat, and its objective is to provide shoulder massage, taking into account both good functionality and beautiful design.

To achieve the above objective, the technical solution of the present device is as follows:

A vehicle seat, comprising a backrest, wherein the combined massage device is fixedly mounted at a shoulder position of the backrest. With the above structure, the shoulder massage device is integrated within a space-limited backrest frame, ensuring both effective massage and aesthetic design.

Compared with the prior art, the present device has the following beneficial effects:
1. With the combined massage device provided by the present device, massage is provided by the rotary massage mechanism and the shiatsu massage mechanism. It is a mechanical massage method with good comfort and sufficient intensity.
2. When not operating, the rotary massage head and the shiatsu massage head are retracted into the mounting holes. In cooperation with foaming, it makes the surface of the shoulder rest flat, thereby preventing the seat from causing an unpleasant bulging sensation.
3. The massage device is driven by an electric motor, and the electric motor is disposed to be perpendicular to the massage head, avoiding a bulky overall seat structure. The massage mechanism has a simple structure, and can be integrated into the shoulder position of the seat back in a more compact way.

### BRIEF DESCRIPTION OF THE DRAWINGS

FIG. 1 is a schematic view of a structure of the device;

FIG. 2 is a schematic view of a massage device integrated into a seat back;

FIG. 3 is a schematic structural view of a rotary massage mechanism;

FIG. 4 is a schematic view showing a spring sheet;

FIG. 5 is a schematic structural view of a shiatsu massage mechanism;

FIG. 6 is a schematic view showing a positional relationship between two second guide portions;

FIG. 7 is a schematic view showing a driving mechanism;

FIG. 8 is a schematic view showing a rotating shaft;

FIG. 9 is a top view.

### DETAILED DESCRIPTION

The present device will be further described below with reference to the embodiments and drawings.

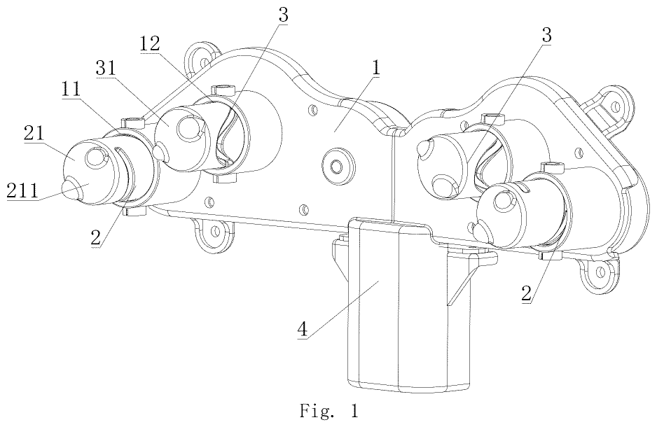

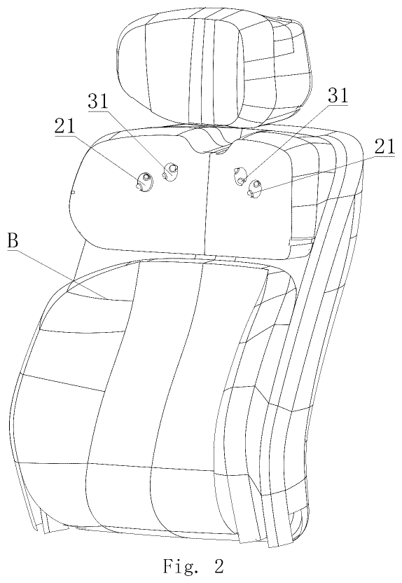

As shown in FIGS. 1 and 2, a massage seat with a combined massage device integrated in a shoulder portion is provided. The massage device is fixedly mounted in a seat back B through a housing assembly 1. Rotary massage mechanisms 2 and shiatsu massage mechanisms 3 are symmetrically provided at two ends of the housing assembly 1. The rotary massage mechanism 2 can apply a massage force to a user's back in a continuous rotation manner, and the shiatsu massage mechanism 3 can intermittently apply a pushing pressure to the user's back in a continuous manner to simulate shiatsu massage. A driving mechanism 4 is further provided on the housing assembly 1. The driving mechanism 4 can drive the rotary massage mechanism 2 and the shiatsu massage mechanism 3 to operate simultaneously.

As shown in FIGS. 1 and 3, the housing assembly 1 has a first mounting inner hole 11 provided at each of its left and right ends. The rotary massage mechanism 2 comprises a cylindrical rotary massage head 21 rotatably disposed within the first mounting inner hole 11. The outer end portion of the rotary massage head 21 has a first massage portion 211 with a curved surface structure. The curved surface structure is further provided with two protrusions so that a better massage effect can be achieved. The outer wall of the rotary massage head 21 is provided with a spiral groove 212 and an annular groove 213. The annular groove 213 is located at the end away from the first massage portion 211. One end of the spiral groove 212 is closed, and the other end thereof is in communication with the annular groove 213. A first guide pin 23 is inserted into the inner wall of the first mounting inner hole 11. The portion of the first guide pin 23 that extends beyond the inner wall is a first guide portion 111. The spiral groove 211 and the annular groove 213 are in sliding cooperation with the first guide portion 111.

When the driving assembly 4 drives the rotary massage head 21 to rotate in a forward direction, the rotary massage head 21 can first be forced to ascend under the guidance of the spiral groove 212 and the first guide portion 111. After the rotary massage head 21 ascends to the highest position, the rotary massage head 21 is then forced to rotate continuously under the constraint of the annular groove 213 and the first guide portion 111 to achieve rotational massage. When the driving assembly 4 drives the rotary massage head 21 to rotate in a reverse direction, the rotary massage head 21 can be forced to retract downward into the first mounting inner hole 11 under the guidance of the spiral groove 212.

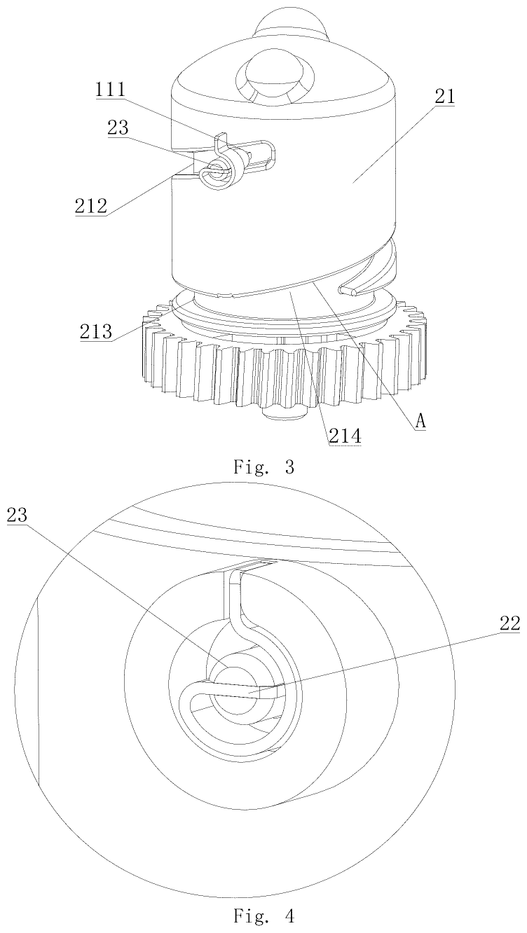

As shown in FIGS. 3 and 4, the first guide portion 111 is mounted on the inner wall by an elastic element spring sheet 22. A buffer groove 214 is widened at the connection between the spiral groove 212 and the annular groove 213. The buffer groove 214 comprises a buffer plane A connecting the spiral groove 212 and the annular groove 213. The spring sheet 22 can provide an upward force to the first guide portion 111. When the rotary massage head 21 rotates in the forward direction, the first guide portion 111 cooperates with the upper surface of the annular groove 213 and slides relative to the annular groove 213. When passing through the buffer groove 214, under the guidance of the buffer plane A, the rotary massage head 21 will not be interfered with by the spiral groove 212, smoothly enters the annular groove 213 and continues to rotate for massage. When the rotary massage head 21 rotates in the reverse direction, the first guide portion 111 transitions from the annular groove 213 to the spiral groove 212. When it is located in the buffer groove 214, the seat cover provides a downward force to the rotary massage head 21, while the spring sheet 22 can provide an upward force to the first guide portion 111. This dual protection ensures that the first guide portion 111 smoothly enters the spiral groove 213 for retraction.

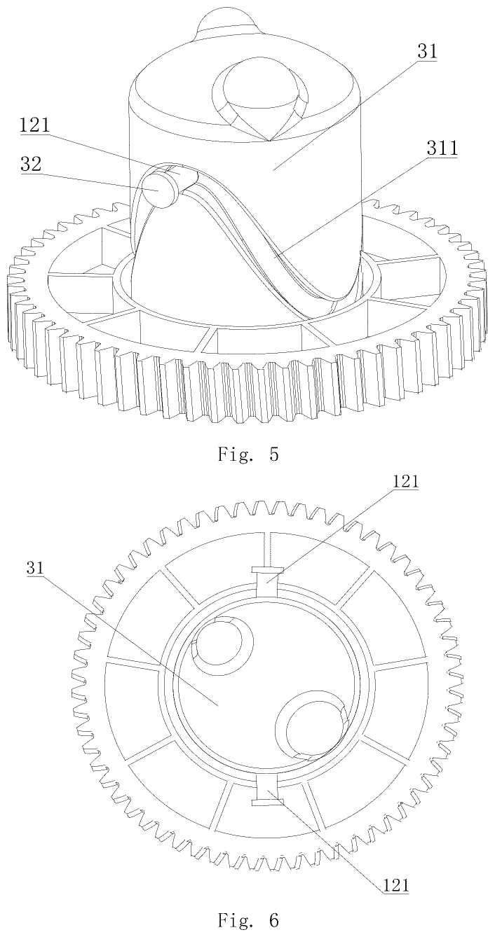

As shown in FIGS. 1 and 5, the left and right ends of the housing assembly 1 are each provided with a second mounting inner hole 12. The shiatsu massage mechanism 3 comprises a cylindrical shiatsu massage head 31 rotatably disposed within the second mounting inner hole 12. The outer wall of the shiatsu massage head 31 is provided with a sinusoidal groove 311. A second guide pin 32 is inserted into the second mounting inner hole 12. The portion of the second guide pin 32 extending beyond the second mounting inner hole 12 is a second guide portion 121. The sinusoidal groove 311 is in sliding cooperation with the second guide portion 121. While the driving mechanism 4 drives the shiatsu massage head 31 to rotate, under the guidance and constraint of the second guide portion 121 and the sinusoidal groove 311, the shiatsu massage head 31 can reciprocate to push out and retract relative to the second mounting inner hole 12. In this embodiment, the sinusoidal groove 311 comprises two sinusoidal cycles. As shown in FIG. 6, two second guide pins 32 are symmetrically inserted into the second mounting inner hole 12, so that the shiatsu massage head 31 is subjected to uniform force and moves smoothly.

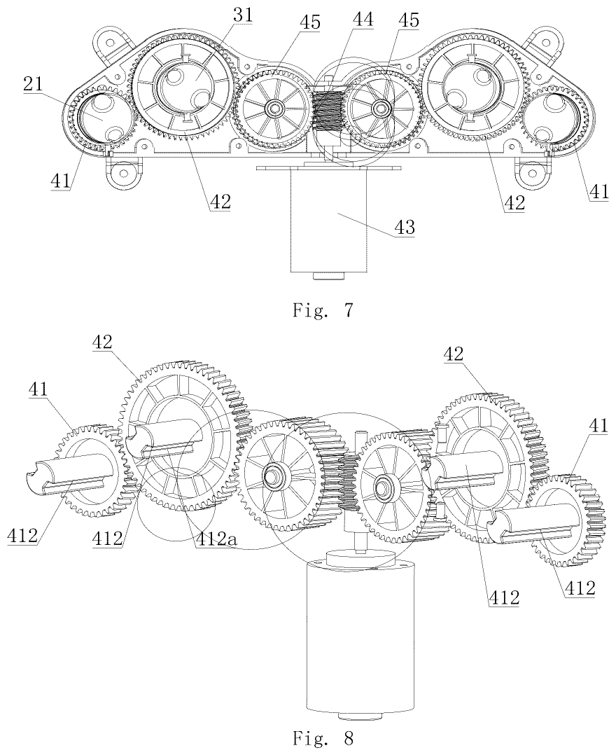

As shown in FIG. 7, the driving assembly 4 comprises an electric motor 43 arranged in the middle portion of the housing assembly 1, a first gear 41 connected to the bottom portion of the rotary massage head 21, and a second gear 42 connected to the bottom portion of the shiatsu massage head 31. The first gear 41 and the second gear 42 located at the same end of the housing assembly 1 are engaged in transmission. The first gear 41 is located on the outside of the second gear 42. The motor 43 is arranged parallel to the first gear 41 and the second gear 42. An output shaft is connected to a worm 44. Two radial sides of the worm 44 are connected to worm wheels 45. The two worm wheels 45 are separately meshed with the second gear 42 to realize transmission.

As shown in FIG. 8, the first gear 41 and the second gear 42 have a rotating shaft 412 extending upward along an axial direction. The rotary massage head 21 and the shiatsu massage head 31 have a central inner hole fitted on the rotating shaft 412. The side wall of the rotating shaft 412 is provided with a limiting groove 412a along the axial direction. The side wall of the central inner hole is provided with a protrusion structure that adapts to the limiting groove 412a. The protrusion structure cooperates with the limiting groove 412a, so that the rotary massage head 21 and the shiatsu massage head 31 can slide up and down while rotating with the first gear 41 and the second gear 42, respectively.

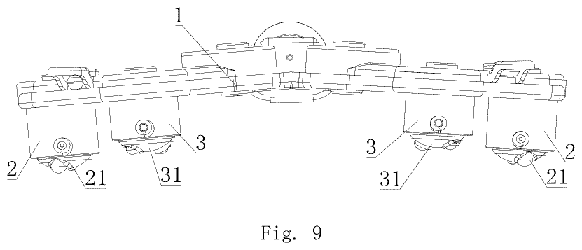

As shown in FIG. 9, the gear set and the electric motor 43 are arranged in a planar layout as a whole. When the electric motor 43 drives the rotary massage head 21 to reverse and retract, the rotary massage head 21 stops at the lowest position. At this time, the shiatsu massage head 31 is also at the lowest position. In cooperation with foaming, this can make the shoulder support surface flat, thereby preventing the vehicle seat from causing an unpleasant bulging sensation.

In this embodiment, the forward and reverse rotation of the rotary massage head 21 are relative concepts. When forward rotation indicates clockwise rotation, reverse rotation indicates counter-clockwise rotation. When forward rotation indicates counter-clockwise rotation, reverse rotation indicates clockwise rotation. Therefore, regardless of whether the forward rotation (ascending process) of the rotary massage head 21 is clockwise or counter-clockwise, it should fall within the protection scope of the present application.

Finally, it should be noted that only preferred embodiments of the present device have been described above. Those of ordinary skill in the art can make various similar expressions without departing from the spirit and claims, and such changes all fall within the scope of protection.

What is claimed is:

1. A combined massage device, characterized in that the combined massage device comprises:
a housing assembly, configured to be fixedly mounted inside a seat back;
two rotary massage mechanisms disposed at left and right ends of the housing assembly, wherein the rotary massage mechanisms are able to apply a massage force to a user's back in a continuous rotation manner;
two shiatsu massage mechanisms disposed at the left and right ends of the housing assembly, wherein the shiatsu massage mechanisms are able to intermittently apply a pushing pressure to the user's back in a continuous manner to simulate shiatsu massage;
a driving mechanism, wherein the driving mechanism is configured to drive the rotary massage mechanisms and the shiatsu massage mechanisms to operate.

2. The combined massage device according to claim 1, characterized in that: the left and right ends of the housing assembly are each provided with a first mounting inner hole, the rotary massage mechanism comprises a rotary massage head rotatably disposed in the first mounting inner hole, an outer end portion of the rotary massage head has a first massage portion, and the driving mechanism is able to drive the rotary massage head to rotate in the first mounting inner hole.

3. The combined massage device according to claim 2, characterized in that: an outer wall of the rotary massage head is provided with a spiral groove and an annular groove, the annular groove is located at one end away from the first massage portion, one end of the spiral groove is in communication with the annular groove; an inner wall of the first mounting inner hole is provided with a first guide portion protruding inward, the spiral groove and the annular groove are in sliding cooperation with the first guide portion; when the driving assembly drives the rotary massage head to rotate in a forward direction, the rotary massage head ascends and then rotates continuously, and the rotary massage head retracts downward when rotating in a reverse direction.

4. The combined massage device according to claim 2, characterized in that: the left and right ends of the housing assembly are each provided with a second mounting inner hole, the shiatsu massage mechanism comprises a shiatsu massage head rotatably disposed in the second mounting inner hole, a sinusoidal groove is provided on an outer wall of the shiatsu massage head, a second guide portion protruding inward is provided on an inner wall of the second mounting inner hole, the sinusoidal groove is in sliding cooperation with the second guide portion; and the driving mechanism is configured to drive the shiatsu massage head to rotate.

5. The combined massage device according to claim 4, characterized in that: two second guide portions protruding inward are symmetrically provided on the inner wall of the second mounting inner hole.

6. The combined massage device according to claim 4, characterized in that: a bottom portion of the rotary massage head is connected to a first gear configured to drive the rotary massage head to rotate, a bottom portion of the shiatsu massage head is connected to a second gear configured to drive the shiatsu massage head to rotate, the first gear and the second gear located at a same end of the housing assembly are engaged in transmission, the driving mechanism comprises an electric motor arranged in a middle portion of the housing assembly, and an output shaft of the electric motor is engaged in power with the two second gears at the two ends of the housing assembly.

7. The combined massage device according to claim 6, characterized in that: the first gears and the second gears at the two ends of the housing assembly are integrally arranged in a planar layout with the electric motor in the middle portion of the housing assembly, and the first gear is located on the outside of the second gear.

8. The combined massage device according to claim 3, characterized in that: the first guide portion is mounted on the inner wall of the first mounting inner hole by means of an elastic element in such a manner that the first guide portion is able to float vertically.

9. The combined massage device according to claim 3, characterized in that: a buffer groove is widened at the connection between the spiral groove and the annular groove.

10. A vehicle seat, comprising a backrest, characterized in that: the combined massage device according to claim 1 is fixedly mounted at a shoulder position of the backrest.
